(19) United States
(12) Patent Application Publication
(10) Pub. No.: US 2025/0111243 A1
(43) Pub. Date: Apr. 3, 2025

(54) COLLABORATIVE LEARNING WITH FULL MODEL ALIGNMENT

(71) Applicant: Robert Bosch GmbH, Stuttgart (DE)

(72) Inventors: Augustine D. Saravanos, Atlanta, GA (US); Filipe J. CABRITA CONDESSA, Pittsburgh, PA (US); Wan-Yi LIN, Wexford, PA (US); Zhenzhen Li, Gibsonia, PA (US); Madan RAVI GANESH, Pittsburgh, PA (US)

(21) Appl. No.: 18/371,596

(22) Filed: Sep. 22, 2023

(51) Int. Cl. G06N 3/098

(52) U.S. Cl. CPC G06N 3/098

(57) ABSTRACT

Methods and systems for training neural networks with federated learning. A portion of a server-maintained machine-learning model is transferred from a server to clients, yielding a plurality of local machine-learning models. At each client, the local models are trained with locally-stored data, including determining a respective cross entropy loss for each local models. Weights are updated for each local model, and evaluated based on a common dataset to obtain activation outputs for each layer. These are transferred to the server without transferring the locally-stored data of the clients, whereupon they are permuted according to the one respective updated weight to match a dimension of the selected client to obtain a matrix, which is sent to each client for permuting the local models based on the matrix. The permuted weights are sent to the server, whereupon they are aggregated and transferred back to the clients for updating of the local models.

### TECHNICAL FIELD

The present disclosure relates to methods and systems of federated learning with foundation models in machine learning models.

### BACKGROUND

Federated learning (a special case of collaborative learning where there is a central server that has connection to all clients) is a machine learning technique that trains a machine learning algorithm via multiple independent nodes, each using its own dataset. Federated learning aims at training a global machine learning model, for instance deep neural networks, based on multiple local datasets contained in local nodes (also referred to as clients) without explicitly exchanging data samples. The learning task is solved by a federation of participating devices coordinated by a central server. Each participating device (client) has a local training dataset which is not uploaded to the server. Instead, each client computes an update to the current global model maintained by the server. The clients communicate this update, but not the training dataset, to the server for updating the global model. The resulting shared model can be trained by learning from the training of the clients, thus allowing users to reap the benefits of shared models trained from the data of the clients without having to transfer or centrally store the data from the clients. This has particular usefulness in situations where the exchange of sensitive or personal data is precluded (e.g., medical information, Internet of Things devices, personal devices such as smart phones).

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3A shows a flow chart of a first exemplary method of training neural networks via federated learning according to a first embodiment.

FIG. 3B shows a flow chart of a second exemplary method of training neural networks via federated learning according to a second embodiment.

FIG. 3C shows a flow chart of a second exemplary method of training neural networks via federated learning according to a third embodiment.

FIG. 4 shows a schematic of a deep neural network with nodes in an input layer, multiple hidden layers, and an output layer, according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The present disclosure relates to federated learning. References herein to a “server” of the federated learning system refer to the centralized server(s) that communicate to the clients to exchange data therewith. For example, one or more servers in the cloud or remote from end users can constitute a server. References herein to a “client” of the federated learning system refer to local nodes or devices corresponding to a particular end user. For example, a smart phone, Internet of Things device, or the like would constitute a client. Each of the server and the client can utilize a respective computer system for machine learning training, such as those described herein.

Federated learning (a special case in collaborative learning where a server is federating the training procedure) is a machine learning technique that trains a machine learning algorithm via multiple independent sessions, each using its own dataset. Federated learning aims at training a global machine learning algorithm (e.g., deep neural networks) based on multiple local datasets contained in local nodes (also referred to as clients) without explicitly exchanging data samples. The learning task is solved by a federation of participating devices coordinated by a central server. Each participating device (client) has a local training dataset which is not uploaded to the server. Instead, each client computes an update to the current global model maintained by the server. The clients communicate this update, but not the training dataset, to the server for updating the global model. The resulting shared model can be trained by learning from the training of the clients, thus allowing users to reap the benefits of shared models trained from the data of the clients without having to transfer or centrally store the data from the clients.

Federated learning has particular usefulness in situations where the exchange of sensitive or personal data is precluded (e.g., medical information, Internet of Things devices, personal devices such as smart phones). Take smart phones as a simple, everyday example. When people type an email or text message, they might have an auto-correct or auto-fill feature that will automatically correct a person's spelling mistake or suggest corrections or additions to the text. This sort of system typically relies upon a machine learning model that is trained based on previous word usage of the user, and might differ from user to user. Because of the sensitive nature of the information used, the raw data of the words types by the user is not sent to a central server to train the model. Rather, the user's smart phone can receive a base model from the server, and can train that model locally to perform auto-correct in a manner that is tailored to that particular user's history of word usage. Information about how the model was trained locally can be sent to the server without requiring the raw data (e.g. the user's words and/or the corrections) to be sent to the server.

Federated learning is a technique that enables data to remain locally stored on clients' devices while the server functions as orchestrator for the learning process, aggregate learned information and synchronize with clients (e.g. users, AI tasks, . . . ). However, the system can experience reduced efficiency and robustness due to issues like data heterogeneity, distribution shifts, and communication can be unreliable and even in cases with hardware failures. Additionally, various federated learning architectures have been proposed, such as single global models and peer-to-peer with individual models, some of which include personalized versions.

FedAvg is a type of federated learning technique in which a distributed machine learning algorithm allows clients to collaboratively train a global server model while keeping their data locally stored and private. It works by sending the initial model from the server to clients, aggregating the clients' updates into a global model, and repeating this process until convergence is achieved. FedAvg enables updating the global model by averaging the knowledge and insights of multiple clients. A major issue with this approach is that during the server aggregation phase, a direct and unsophisticated interpolation would corrupt information provided by the clients. However, clients often have heterogeneous data as data across different devices may have varying distributions, quality, and feature spaces. Dealing with such heterogeneous data poses challenges in aggregating models effectively and achieving good generalization performance. Secondly, devices often hold non-independent and identically distributed (non-IID) data due to their diverse sources and contexts. Learning from non-IID data introduces challenges in model aggregation and convergence.

Given the aforementioned challenges and the variety of federated learning architectures and frameworks, the present disclosure aims to address these issues by proposing a novel federated learning framework. The disclosed approach incorporates a “rebasin” technique, uses it to align model knowledge and bring the aligned knowledge into the federated learning process. More specifically, after the server receives updates from clients, it first uses the rebasin technique to permute the weights of models so the knowledge provided in the updates is aligned. Then, the aligned knowledge can then be aggregated. This results in a refined and better-aligned model knowledge being pooled together within the same loss.

Whereas prior works present knowledge alignment in federated learning, it is done in a recursive layer-wise manner while freezing other layers. This introduces as many as number of layers in the deep network communication rounds and introduces communication overhead.

To address the problems of misaligned representation from client model updates, this disclosure proposes embodiments including the following method. In embodiments, systems and methods herein leverage the rebasin technique to modify the model aggregation in the server during federated learning. Instead of directly averaging (interpolation) collected models based on the number of examples from each party as in FedAvg, our invention involves fixing one model and then applying the rebasin technique to the remaining models before interpolation. By doing so, the methods and systems disclosed herein bring together refined and better-aligned model knowledge within the same loss basin, which is then fed to the interpolation operator in each communication round. This disclosure presents a framework for achieving model alignment on siloed datasets under the setting of federated learning.

The present disclosure refers to both collaborative learning and federated learning. In embodiments, for collaborative learning, the system learns one model per client; for federated learning the system learns one model for all clients.

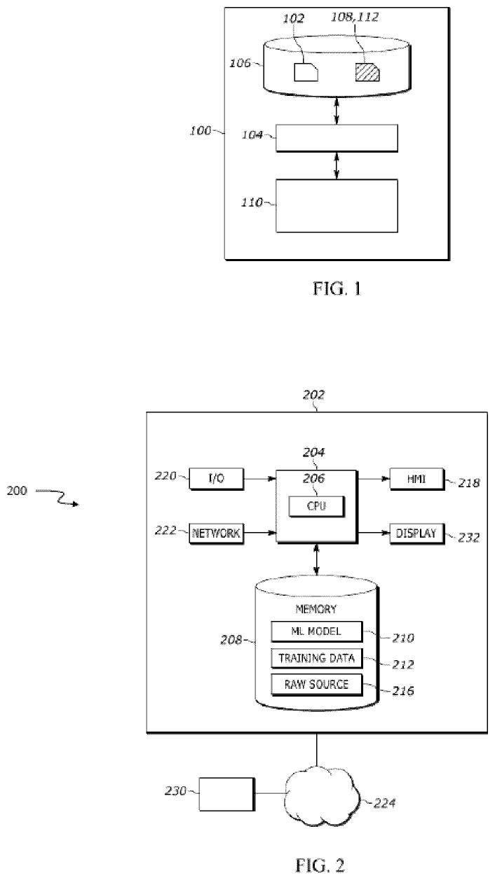

The federated learning system can utilize machine learning training and processes shown in FIGS. 1-2. FIG. 1 shows a system 100 for training a neural network, e.g. a deep neural network. The neural network being trained may reside on the server or the client. In other words, both the server and the client may utilize the teachings of FIG. 1. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the untrained' neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104. but may in general be of a type as described above for the data storage interface 104.

The structure of the system 100 is one example of a system that may be utilized to train the models utilized by the federated learning system described herein. Additional structure for operating and training these machine-learning models is shown in FIG. 2.

FIG. 2 depicts a federated learning system 200 configured to execute and train the machine-learning models described herein, for example the neural networks or deep neural networks. The system 200 can be implemented to perform the federated learning processes described herein. The system 200 may include at least one computing system 202. The computing system 202 may be part of or executed by a client device, such as a smart phone, Internet of Things device, medical device, or other device such as those described herein with reference to FIGS. 6-11 described below. By way of example and not by way of limitation. computing system 202 may be an embedded computer system, a system-on-chip (SoC), a single-board computer system (SBC) (such as, for example, a computer-on-module (COM) or system-on-module (SOM)), a laptop computer, a personal device such as a smart phone or tablet, a mesh of personal devices, or a combination of these. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system-on-chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud, enabling the device executing the computing system 202 (e.g., client device) to communicate with the server 230.

The external network 224 may be referred to as the world-wide web or the Internet. The external network 224 may establish a standard communication protocol between computing devices. The external network 224 may allow information and data to be easily exchanged between computing devices and networks.

One or more servers 230 may be in communication with the external network 224. Each server may include a computing system, such as computing system 202, so that the server 230 is configured to perform machine learning and train neural networks. Of course, in keeping with the spirit of this disclosure, certain personal or sensitive raw source data 216 that originate from a particular client device may not transfer to the server 230, and thus the raw source data at the server may be non-existent or may be completely independent of the raw source data on a computing system 202 of a client device. During operation of the federated learning system, as will be described below; the computing system 202 associated with a client device may exchange parts of the training data 212 but not the raw source data 216 or any personal data so as to preserve privacy for any sensitive personal data residing on the client device. The server 230 can then access this information via connection to the network 224, and update its stored models on the server-side.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuity or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, camera, sensors, etc. Examples of output devices include monitors, screens, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as a keyboard, mouse, touchscreen, voice input devices (e.g., microphone), and other similar devices. The computing system 202 may include a display device 232. The computing system 202 may include hardware and software for outputting graphics and text information to the display device 232. The display device 232 may include an electronic display screen, projector, printer, speaker, or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. In particular, a client device may implement the computing system 202, and the server 230 may also include its own computing system 202. The particular system architecture selected may depend on a variety of factors.

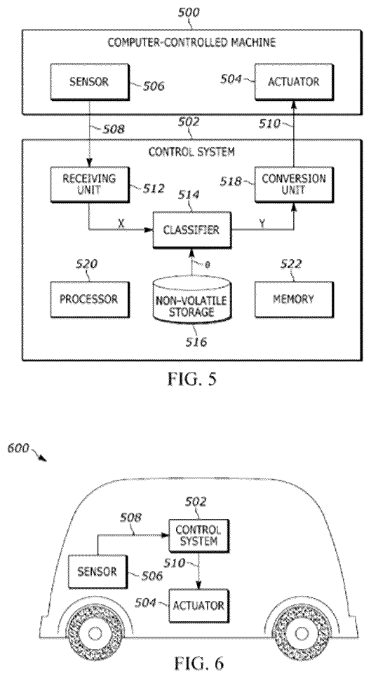

The federated learning system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). The raw source dataset 216 may include sensitive or personal data with heightened security necessities, and therefore the raw source dataset 216 may not transfer from the client device to the server 230. Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The neural network algorithm may be configured to auto-correct text or speech based on the context of the words from the individual.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a person in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., a particular word, in the case where text or spoken words is the input). The raw source data 216 may be derived from a variety of sources. For example, the raw source data 216 may be actual input data collected by a machine-learning system. The raw source data 216 may be machine generated for testing the system. As an example, the raw source data 216 may include raw images or video from a camera, spoken words from a microphone, or typed or written words from a keyboard or touch screen, or the like.

This disclosure addresses the challenge of aggregating knowledge during federated learning when the clients have heterogeneous and non-IID (Independent and Identically Distributed). data distribution. Consider that, knowledge (i.e., weights) from clients with such different data distribution should be aligned before aggregating clients' updated weights.

To address growing size of massive training datasets and regularization on data protection across boarders or users, federated learning (FL) allows learning one common model for all clients from not only on their own data but also with knowledge from other nodes. In this scheme, each client updates its local model on local data asynchronously, and send model weights or effectively, gradients, to the server. While many advances have been made to FL in personalization, communication efficiency, and privacy preservation, little has been addressed in how to aggregate the shared model weights or gradients. One way is to assume the weights or gradients will be directly interpolated, with possibly different weights and schedules.

Furthermore, in FL clients often have heterogeneous data distribution and quality, which naturally occurs due to diverse sources (geographical location, usage, etc) of the clients. Clients often hold non-independent and identically distributed (non-i.i.d.) data. Heterogeneous and non-i.i.d. data poses extra challenge in aggregating models, as local models are more likely to be in very different local minimum in the high-dimensional parameter space, and naively averaging them could lead to performance loss.

To tackle extra challenges posted by heterogeneous and non-i.i.d. data on the clients, this disclosure presents alignment of the models with Git Re-basin before naive aggregation during FL. Git Re-basin aligns two trained models by permuting parameters of one to the basin of the other (e.g. based model). Doing so before interpolating model weights improves accuracy of the aggregated model.

This disclosure incorporates Re-basin for model aggregation at the server for FL, and the aggregated aligned weights are then send back to the clients to replace their local models. As commonly in FL, there could be more than two clients, hence multiple, instead of one, model parameters can be aligned to a single base model. This disclosure provides refined and better-aligned model knowledge being pooled together within the same loss basin and making subsequent aggregation more effective, especially under heterogeneous and non-i.i.d. local data distributions.

Furthermore, if a small evaluation dataset is available/public to all compute nodes, the corresponding activation of the public evaluation dataset on the models can be used for computing permutations of the model parameters. With activation of a public dataset, the models alignment could align better and further improves convergence and accuracy of models learned by CML.

### Main Contributions

This disclosure presents using Git Re-basin to align models and use them as regularization during collaborative training under heterogeneous and non-i.i.d. data distribution.

With public evaluation dataset, the presented approach is extended to utilizing activations for model alignment which further improves convergence in collaborative training.

Then identify conditions of data distribution with which collaborative training can benefit from Git Re-basin.

And analyze representations of aligned models and the learnt local model via agreements.

Federated learning allows model training across multiple clients with the knowledge of other clients without exchanging data. FL required the knowledge, usually model weights or gradients, to be aggregated at the server and this aggregated weights will replace clients' local weights.

Federated Learning with Matched Averaging via a federated learning framework that uses a layer-wise weights matching technique to associate the parameters of different client models before averaging them to obtain the global model parameters. This approach requires communication rounds as many as number of layers in the deep network for one round of model aggregation. Later, Git Re-basin addresses diverse but equivalent set of representations due to the symmetry of deep networks, and proposed activation matching and full-model weight matching for aligning deep networks. However, this method is only used for ensemble knowledge from well-trained neural networks. Therefore, to establish the framework and to utilize the technique in training from scratch stage can potentially increase the performances, thanks to frequent information exchange.

Algorithm 1
Algorithm 1 CoRebasin
1: Initialize: [symbol] , i ∈ [symbol]
2: for t = 0, . . . , T - 1 do
3: for i ∈ [symbol] do
4: for For all j ∈ [symbol] send [symbol] to i do
5: [symbol] = Rebasin (⊖ⱼ^{ⁱ} → ⊖ᵢ)
6: end for
7: $\text{?} = arg min \text{?} {ℒ}_{i} ( {𝒟}_{i} ; \text{?} ) + \frac{λ}{2} {\sum }_{j ∈ {𝒩}_{i}} {‖ \text{?} - \text{?} ‖}^{2}$
8: end for
9: end for [symbol]
indicates data missing or illegible when filed

Collaborative Rebasin: also referred to as (Rebasin) is for any given two neural network models A and B, with L layers and parameters Θ_{A} and Θ_{B}, respectively, this disclsoure defines the following rebasin operator

$$Rebasin ( {Θ}_{B} \to A ) = {π}_{B \to A} ( {Θ}_{B} ) , \qquad ( 1 )$$

where π_{B→A}(⋅)={Pₗ}_{l=1, . . . , L} is the “optimal layer-wise permutation” of model B so that it matches model A and Pₗ is the permutation matrix for each layer l=1, . . . , L. This permutation can be found through the following two methods:

First, Activation matching: For any dataset D, denote the activation of model A and B on the dataset as Z_{A,D} and Z_{B,D}. Each optimal permutation matrix Pₗ is given by Pₗ=argmin_{P}_{ₗ}_{∈S}_{_{d}}∥Z_{A,D}−PₗZ_{B,D}∥² with S_{d} to be the set of permutation matrices.

Second, Weights matching: The optimal permutations are given by π_{B→A}=argmin_{π}∥Θ_{A}−π(Θ_{B})∥₂ with π={Pₗ}_{l=1, . . . , L}.

A Communication graph is defined as an assumption that G(V,E) be a connected graph network where V and E are the nodes and edges sets. For any entity m,n∈V, if E(m,n)/=0, then node m can communicate with node n. Call G a complete communication graph if E(m,n)/=0 for any nodes m,n.

Consider a system consisting of N entities n=1,2, . . . , N with communication graph G(V,E) defined as defined above. Assume that in the communication period, each entity can exchange model information (e.g. send and receive parameters, gradients, logits on public dataset), but cannot share any private data information based on G(V,E). Denote the locally stored private dataset to be [symbol] ={Xₙⁱ, yₙⁱ}ᵢ₌₁^{N}^{ₙ}. Furthermore, each entity is associated with a local training loss [symbol] ( [symbol] ; Θₙ). Assume that for each entity n, the neural network model is parameterized by Θₙ. Denote the neighbors of entity n as Nₙ={m∈V|(n,m)∈E}. If the communication graph is not complete, This method presents the Collaborative Rebasin to collaboratively training individual local models. Else when the communication graph is complete, then this method presents the Federated Rebasin to train a global model. In the training process, Assume that there are T communication round, and the initial parameters set is Θ₀. At each step, the model for node n is Θₙ^{t} and the model for entity m rebasined to model of entity n is denoted as Θ_{m→n}^{t}.

The aim of the Collaborative Rebasin (CoRebasin) approach is twofold:

First, leverage the rebasin idea within a collaborative training framework by including it as an intermediate step to facilitate training among different entities.

Second, boost the performance of rebasin by incorporating it in a collaborative setting where the parameters are exchanged-instead of only using for model merging.

Algorithm 2 FedRebasin

| | |
|---|---|
| 1: | Initialize: Θ⁰, i ∈ [symbol] |
| 2: | for t = 0,...,T − 1 do |
| 3: | for i ∈ [symbol] do |
| 4: | Server sends Θ^{t} to i. |
| 5: | Θᵢ^{t} ← Θⁱ |
| 6: | Θᵢ^{t+1} = arg min_{Θ,} [symbol] ᵢ( [symbol] ᵢ;Θᵢ^{t} ) |
| 7: | Θ_{n→r}^{t+1} = Rebasin(Θₘ^{t} → r) |
| 8: | Server receives Θᵢ^{t} from i. |
| 9: | end for |
| 10: | Θ^{t+1} = GlobalServer({Θᵢ}_{t∈v}) |
| 11: | end for |

One key aspect is that performing rebasin steps before attempting to enforce consensus between the parameters of neighboring nodes will increase training efficiency. Let T be the total number of communication rounds during which each node i sends its parameters Θᵢ to its Θᵢ^{t+1} neighbors j∈Nᵢ. At every round t=0, . . . , T−1, each node solves the following problem

$${Θ}_{i}^{t + 1} = {arg min}_{{Θ}_{i}} \underbrace{{\sum }_{n = 1}^{{N}_{i}} {ℒ}_{i} ( {𝒟}_{i}^{n} ; {Θ}_{i}^{t} )}_{training with local data} + \underbrace{\frac{μ}{2} {\sum }_{j ∈ {𝒩}_{i}} {‖ {Θ}_{i} - {Θ}_{j \to i}^{t} ‖}^{2}}_{consensus with neigboring nodes} \qquad ( 2 )$$

where

$${Θ}_{j \to i} = Rebasin ( {Θ}_{j} \to {Θ}_{i} ) . \qquad ( 3 )$$

The first part of the objective is the local loss function based on the private data Dᵢ of node i. The second part encourages consensus between the parameters of i and its neighbors j∈Nᵢ.

Let G(V,E) be a connected graph network where V and E are the nodes and edges sets, respectively. Each node n∈V contains a local training dataset [symbol] ={Xₙⁱ, yₙⁱ}ᵢ₌₁^{N}^{ₙ}, where Nₙ is the number of available training samples. This disclosure is particularly applicable to scenarios where data at different nodes are limited, diverse and disjoint, i.e., all Nₙ are relatively low and Dₙ∩Dₘ=Ø, for any n,m∈V with n/=m. In addition, each node also contains a DNN with parameters Θₙ. Furthermore, each node has a set of neighbor nodes that is defined as Nₙ={m∈V|(n,m)∈E}.

Based on experimental results, FedRebasin works significantly better than FedAvg. FedRebasinPrivate performance is close to the one of FedRebasin and significantly better than FedAvg, FedRebasinDist, and even outperforms FedRebasin. CoRebasin has exhibited advantages over Simple Rebasin and CoNaive in two clients setting

### Consider in a First Exemplary Embodiment

Many real-world applications often rely on centralized training for deep models, which requires gathering all data before using the data for training. However, this approach is not always feasible or appropriate. One limitation arises when data are stored in different data centers, where the vast volume of data makes it impractical to transmit the data to one data center for training. Additionally, regulatory constraints may prohibit data sharing across entities or borders. Finally, scenarios involving streaming data at regular (and frequent) intervals pose challenges due to the technical challenges associated with transmitting the entirety of the data to a single central server. For example, one smart space (campus, city, airport etc) will have multiple sensors (acoustic sensors, cameras, infrared sensors etc) deployed, each with very limited memory and communication capacity while the signals are being streamed in real time.

Apart from the technical difficulties in transmitting data from devices to a central server, gathering siloed data for processing and training also presents drawbacks. Data transmission, especially when dealing with large datasets, demands substantial bandwidth, resulting in communication latency. Moreover, data privacy concerns heighten when data is transmitted and leaves client devices or data storage centers. The transmission process also incurs additional energy costs, which might make it less adequate for low-energy/low-power settings. This means that there is a large range of applications where it is possible to side-step data transmission and synchronization costs while achieving competitive model performance compared to models trained on centralized datasets.

To address the aforementioned concerns of this first exemplary embodiment, distributed learning (also known as decentralized learning or and federated learning) have their training process performed across multiple clients (compute, data, application) instead of centralizing all the data and compute in a single location. One thought is introducing FedAvg. a federated learning approach designed to enable distributed training of deep learning/machine learning models using locally stored and distributed data. Federated learning is a technique wherein data remains localized on clients' devices, while the server acts as the central orchestrator of the learning process.

Federated learning systems generally operate in the following manner: Firstly, decentralized entities train models based on their own locally-stored data. Secondly, these clinets communicate their most recent model weights to the central server, who aggregates the collected model weights. Thirdly, the server facilitates communication with the clients and disseminates the aggregated model to them. Upon receiving the updated model, each clients replaces their own model with the provided aggregated model and performs additional training on their respective local data, akin to the initial step of local training. These iterative steps continue until convergence or until the system achieves satisfactory results.

A major issue with this approach is that during the server aggregation phase, a direct and unsophisticated interpolation would corrupt information provided by the clients. To improve the aggregation stage, a layer-wise process of matching under the setting of federated learning can be used. Apart from federated learning setting, the loss landscape of interpolation across two models without a centralized server hosting aggregation and discovered that unsophisticated interpolation may lead to an increase in loss and a drop in accuracy for the aggregated model. Further, it can be achieved in different ways to perform permutation to align deep models.

This disclosure aims to further improve model aggregation by integrating the rebasin technique into the federated learning strategy. Specifically, leveraging the rebasin technique to modify the model aggregation in the server during federated learning. Instead of directly interpolating collected models based on the number of examples from each party, this method involves fixing one model and then applying the rebasin technique to the remaining models before interpolation. Uniquely, this approach only needs one communication round for the whole model, instead of one communication per layer of the network. This disclosure significantly reduces communication overhead compared. Also this method optimizes the permutation for the whole model instead of permute one layer at a time. By doing so, this disclosure brings together refined and better-aligned model knowledge within the same loss basin, which is then fed to the interpolation operator in each communication round. This disclosure presents a framework for achieving model alignment on siloed datasets under the setting of federated learning.

Improvements: Consider the Federated Learning method, known as FedAvg. under decentralized training setting based on locally stored and distributed data. However, the existing federated learning system merely employs simple model interpolation from each party without considering mismatches among models arising from the symmetry of neural networks. Such mismatches can lower convergence speeds and limit test accuracy and generalization capabilities in various scenarios. On the other hand, the rebasin focuses on the problem of permuting the weights of the one well-trained model towards the basin of the other well-trained model, and the permutated knowledge is not introduced to the training stage or under the federated learning setting to modify the aggregation process in the server side.

This disclosure introduces a model aggregation approach that retains locally stored data, allowing each party in the system to train their own deep models with aligned knowledge synchronized from aggregations. This consensus on aligned knowledge can significantly enhance performance, including convergence rate, training robustness, and generalized accuracy limit, among other benefits. The proposed method empowers a more efficient and effective collaboration process for federated learning.

Applications: This embodiment of the disclosure can be used by training deep models or neural networks using federated learning, decentralized learning, multiple party collaborative learning in industrial IoT, sensor networks, autonomation, artificial intelligence for production. One of the applications of this embodiment is used as a general approach for model aggregation under federated learning setting for any of federated learning algorithms.

Problem Formulation: Consider a system consisting of several entities (e.g. clients or learning agents) where each entity has its own private data stored locally. All entities have access to a computing unit and can communicate with the server in the system (e.g. a reference entity). This server is a separate unit which does not have its own private data and does not participate in the training procedure. Each entity is allowed to send/receive parameters to/from the server but cannot share their own private data. The goal of the system is to collaboratively train models that are useful (within a definition of usefulness agreed by all the interacting entities) to all the entities in the system.

Background: Consider N entities, where each entity n=1, 2, . . . N has its own private data Dₙ={xᵢⁿ, yᵢⁿ}_{{i=1}}^{M}^{ₙ} and parameters θₙ∈R^{θ}. Assume that the entities all can communicate with the server S. Each entity is allowed to send/receive parameters but cannot share their own private data. Furthermore, each entity n∈[N] is associated with a local training loss Lₙ(xₙ, yₙ; θ). Our goal is to find the “global” parameters θ that minimize the sum of all training losses, i.e.,

$$θ = arg {min}_{θ} {\sum }_{n} {L}_{n} ( {x}_{n} , {y}_{n} ; θ ) \qquad ( 1 )$$

associated with a local training loss Lₙ(xₙ, yₙ; θ).

### Flow of Rebasin with Permutation for Two Models

1. Permutation of model weights: permutation is a linear transformation of model parameters in a layer-by-layer fashion. The permuted l^{th} fully-connected layer (in a multi-layer perceptron) parameterized by [symbol] ∈R^{d}^{ₗ}^{×d}^{ₗ₊₁} and bias bₗ∈R^{d}^{ₗ} with the permutation matrix P∈S^{d}^{ₗ₊₁} can be written as:

$$= {PW}_{l} , {B}_{l} = {PB}_{l} \qquad ( 2 )$$

Convolutional layers can be permuted in a similar fashion

2. Permuting one model to the basin of the other with weights matching: Assuming there are two model A and B and each model contains a set of parameters θA and θB. Weights matching aims to find the optimal transformation matrix P that

$$P = arg min {\sum }_{i = 1}^{n} ‖ {Θ}_{A} - P {Θ}_{B} ‖ \qquad ( 3 )$$

3. Permuting one model to the basin of the other with activation matching: Assuming there are two model A and B and each model contains n layers. By running the model through one data point it can obtain a set of activations, where the activation for layer l is Zₗ=[z_{l,1}^{T}, . . . , z_{l,n}^{T}]. One will conduct permutation at each layer with the permutation matrix Pₗ for the lth layer

$${P}_{l} = arg {min}_{{P}_{l} ∈ {S}^{{d}_{l + 1}}} {\sum }_{i = 1}^{n} ‖ {Z}_{l + 1 , i}^{( A )} - {P}_{l} {Z}_{l + 1 , i}^{( B )} ‖ \qquad ( 4 )$$

This exemplary embodiment of Federated Rebasin includes the following in addition to the steps above:

Assume T communication rounds and some initial global parameters θ⁰ (e.g. randomly initialized parameters, or from pre-trained model parameters, or arbitrary initialization). Moreover, assume that at each round the central server wishes to transfer the parameters θ₂, . . . θ_{N} within the basin of the parameters θ₁.

The following updates will take place at every communication round, for t=0, 1, . . . , T−1: (or until convergence)

4. The central server communicates with entities the latest available model θ^{t}.

5. (entity) Local updates. For each entity, perform local updates based on locally stored data. That is, for entity n, set θ_{n,0}^{t}=θ^{t}. For local training epochs k=1,2, . . . , K, perform updates based on SGD (Stochastic Gradient Descent, or one can choose other optimizers) that minimizes local loss Lₙ(xₙ, yₙ; θ_{n,k}^{t}). Set θ_{n,k}^{t+1}=θ_{n,K}^{t}.

6. (entity-server) Transmit model: each entity n∈[N] sends its updated local model θ_{n,k}^{t+1} to the central server.

7. (server) Find optimal permutations for models. The central server find the optimal πₙ^{t+1} for all n=2, . . . , N such that

$${π}_{n}^{t + 1} = arg {min}_{P} {‖ {θ}_{1}^{t + 1} - P ( {θ}_{n}^{t + 1} ) ‖}_{F} \qquad ( 5 )$$

which is referring to the weights matching version of rebasin. Note that this notion of 1^{st} entity can be arbitrarily chosen and change for each round.

If the server has a local dataset for alignment, if use the activation matching version of rebasin in [1], assume the model-1 as a coordinator node, local data points are i∈D and solve the optimal permutations (a permutation matrix in rebasin technique to address symmetry of neural networks) for all such that n=2, 3, . . . , N

$${π}_{n}^{t + 1} = arg {min}_{P} {\sum }_{i ∈ D} {‖ {Z}_{i}^{1 , t + 1} - {PZ}_{i}^{n , t + 1} ‖}^{2} \qquad ( 6 )$$

Here, each Zᵢ^{n,t+1} is the activation of model θₙ^{t+1} on data point i. Subsequently, for n=2, . . . , N, results in the permuted weights \tilde{θ}ₙ^{t+1}=πₙ^{t+1}(θₙ^{t+1}).

8. (server) Model aggregation. Compute the new global model weights θ^{t+1} through an averaging step s, with the linear combination weights to be

$$\frac{1}{{S}_{n}}$$

for client n. Here Sₙ is the number of examples client n has for local training. However, the strategy of how to perform the linear combination is not limited to be related to the number of examples per client.

9. (server-client): server sends the global model θ^{t+1} to all entities

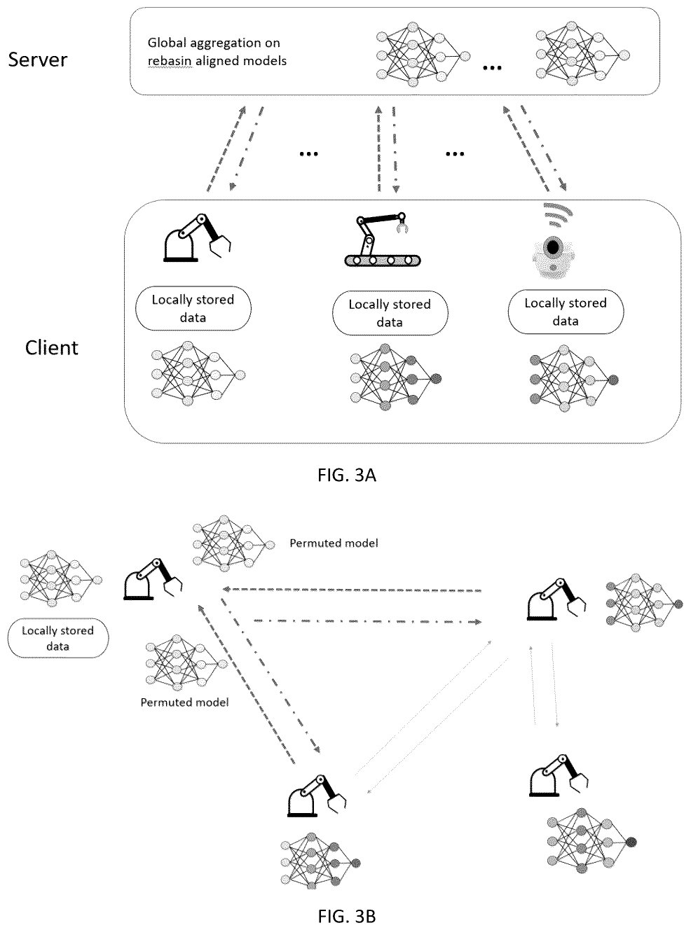

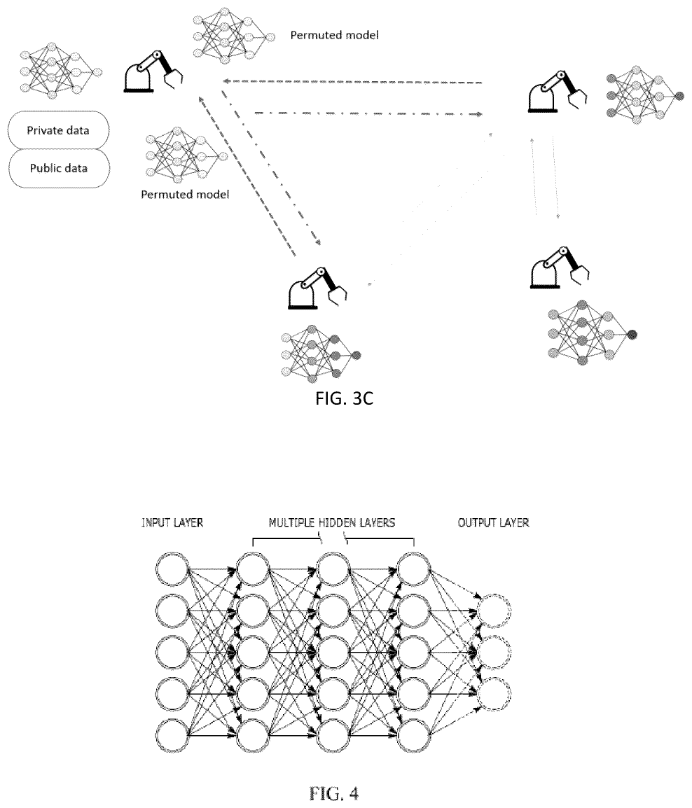

FIG. 3A is flow diagram for FedRebasin where each entity (client) sends updated parameters to the central server, and the central server first select one client's parameter as base and permute the other client's parameters to the base. And the central server aggregates the parameters (permuted and base) to one updated global model and sends it to all entities.

Consider in a second exemplary embodiment:

Many real-world applications of deep learning models often rely on centralized training, which involves gathering all data in the same location (server, machine, or cluster of machines) before processing. However, this approach is not always feasible or appropriate for several reasons. One such limitation arises when dealing with data stored in isolated data centers, where the vast volume of data makes it impractical to transmit and gather for training. Additionally, regulatory restrictions may prohibit data sharing across companies or countries. Furthermore, scenarios involving streaming data generated every second pose challenges due to the infeasibility of transmitting all the data to a central server. Apart from the technical difficulties in transmitting data from devices to a central server, gathering siloed data for processing and training also presents drawbacks. Data transmission, especially with large datasets, demands substantial bandwidth, resulting in communication latency. Moreover, data privacy concerns escalate when data is transmitted and leaves client devices or data storage centers. This transmission process also incurs additional energy costs. Therefore, in many instances, a problem that needs to be solved is to design methods that circumvent data transmission while achieving competitive model performance compared to models trained on centralized datasets are needed in applied fields.

To conquer the difficulties, distributed learning, also known as decentralized learning, or federated learning, offers methods where training is performed across multiple nodes instead of centralizing all the data in a single location. In this approach, the data remains distributed on individual devices, and the learning process occurs locally on each device. The main strengths of distributed learning are its ability to address privacy, security, and scalability concerns associated with centralized data storage and processing. However, there are some challenges related to decentralized data. Firstly, heterogeneous data is one of the main challenges in distributed learning as data across different devices may have varying distributions, quality, and feature spaces. Dealing with such heterogeneous data poses challenges in aggregating models effectively and achieving good generalization performance. Secondly, devices often hold non-independent and identically distributed (non-IID) data due to their diverse sources and contexts. Learning from non-IID data introduces challenges in model aggregation and convergence.

Given the practical problems and challenges mentioned earlier, this disclosure aims to tackle the issues through the introduction of a novel collaborative learning strategy. This approach incorporates the “rebasin” technique used to align model knowledge and bring the aligned knowledge into the collaborative learning process. More specifically, under the setting of collaborative learning, in training stage for any model A in the system, the rebasin technique is applied to permute the weights of other models, and then the aligned knowledge is introduced as a regularization for model A in its training stage. This results in a refined and better-aligned model knowledge being pooled together within the same loss basin and subsequently fed to the aggregation operator during each communication round. This disclosure introduces a framework for an aligned strategy in collaborative training on siloed datasets.

Generally, the rebasin focuses on the problem of permuting the weights of the one well-trained model towards the basin of the other well-trained model, while this disclosure allows for permuted knowledge exchange during the training procedure.

In this disclosure, a collaborative learning method that stores data locally, and each party of the system trains their own model locally with information for aligned knowledge shared by other parties is presented. Here, the knowledge is shared directly between parties instead of having a central server aggregating the knowledge. The aligned knowledge is introduced as regularization in the training stage. In this way, it enhances performance, including convergence rate, training robustness, and generalized accuracy limit, among other benefits. The proposed method empowers a more effective collaboration process for collaborative learning.

Application: This disclosure can be used by training deep models or neural networks using decentralized learning, multiple party collaborative learning in industrial IoT, sensor networks, autonomation, artificial intelligence for production.

The rebasin focuses on the problem of permuting the weights of the one fully-trained model towards the basin of the other fully-trained model and the study is limited to only two fully-trained models This disclosure uses the idea of using the rebasin approach in the training across multiple (more than two) entities in their training stages.

Problem Formulation: Consider a system that consists of several entities, and each client has its own private data stored locally. All parties have access to a local computing unit and can communicate with some of the other entities in the system. Each client is allowed to send/receive parameters but cannot share their own private data. In other words, those entities are collaboratively training their models by sharing knowledge in the system.

First, consider N entities, where each client n=1,2, . . . , N has its own private data Dₙ={xᵢⁿ, yᵢⁿ}ᵢ₌₁^{M}^{ₙ} and parameters θₙ∈R^{θ}. Assume that the entities follow from a communication graph, denoted as G∈R₊^{n×n}, where nodes in G are the entities and the edges are connections between entities. Each client is allowed to send/receive parameters but cannot share their own private data. Furthermore, each client is associated with a local training loss Lₙ(xₙ, yₙ, θ). Our goal is to find the “global” parameters θ that minimize the sum of the training loss of entities, i.e.,

$$θ = arg min {\sum }_{n ∈ \{ 1 , 2 , … , N \}} {L}_{n} ( {x}_{n} , {y}_{n} , θ ) . \qquad ( 7 )$$

Rebasin with permutation for two models:

1. Permutation of model weights: permutation is a linear transformation of model parameters in a layer-by-layer fashion. The permuted l^{th} fully-connected layer (in a multi-layer perceptron) parameterized by [symbol] ∈R^{d}^{ₗ}^{×d}^{ₗ₊₁} and bias bₗ∈R^{d}^{ₗ} with the permutation matrix P∈S^{d}^{ₗ₊₁} can be written as:

$$= {PW}_{l} , {B}_{l} = {PB}_{l} \qquad ( 8 )$$

The subsequent layer Wₗ₊₁ must be permuted as well. Convolutional layers can be permuted in a similar fashion.

2. Permuting one model to the basin of the other: Assuming there are two model A and B and each model contains the set of n layers Zₗ=[z_{l,1}^{T}, . . . , z_{l,n}^{T}]. One will conduct permutation at each layer with the permutation matrix Pₗ for the l^{th} layer

$${P}_{l} = arg {min}_{{P}_{l} ∈ {S}^{{d}_{l + 1}}} {\sum }_{i = 1}^{n} ‖ {Z}_{l + 1 , i}^{( A )} - {P}_{l} {Z}_{l + 1 , i}^{( B )} ‖ \qquad ( 9 )$$

Here, a solution is a Collaborative Rebasin Approach

Assume T communication rounds and one set of initial parameters θ⁰. Moreover, assume that at each round for any given client (node in the graph) i it wishes to transfer the parameters

$${\{ {θ}_{j} \}}_{\{ j : G ( i , j ) \neq 0}$$

within the basin of its own parameters θᵢ. More specifically, the following steps will take place.

1. Initiate each client's model [symbol] to be θ⁰.

2. The following updates will take place at every communication round, for t=1,2, . . . , T:(or until convergence) repeat step 3-6.

3. Send and receive model parameters to neighbors. For each client i, receive models from its neighbors j: G(i, j)≠0 and send model θᵢ^{t} to its neighbors.

4. Find optimal permutations for models. For each client i, calculate corresponding permutations for received models referring to θᵢ^{t}.

$${π}_{j}^{t} = arg {min}_{P} {‖ {θ}_{i}^{t} - P ( {θ}_{j}^{t} ) ‖}_{F} ( for weights matching ) , \qquad ( 10 )$$

$$and$$

$${π}_{j}^{t} = arg {min}_{P} {\sum }_{d ∈ {D}_{i}} {‖ {Z}_{d}^{i , t} - {PZ}_{d}^{j , t} ‖}^{2} ( for activation matching ) \qquad ( 11 )$$

Here, each Z_{d}^{j,t} is the activation of model θⱼ^{t} on data point d∈Dᵢ. After πⱼ^{t} is solved, compute permuted models [symbol] =πⱼ^{t}θⱼ^{t} for all j: G(i,j)≠0

5. Use permuted model as regularization. For each client i, update its loss term to

$$= {Loss}_{i} + {\sum }_{j : G ( i , j ) \neq 0} {λ}_{j} {‖ {θ}_{i}^{t} - ‖}_{2} \qquad ( 12 )$$

6. Back propagate and update local parameters θᵢ^{t}

FIG. 3B is flowchart for Co-rebasin: each client receives model parameter sets from its neighbors, then permute the received parameters to align with the client's own parameter space, and incorporate such permuted parameters into the client's parameters

Consider in a third exemplary embodiment:

Many real-world applications of deep learning often rely on centralized training, which involves gathering all data in the same location (server, machine, or cluster of machines) before processing. However, this approach is not always feasible or appropriate for several reasons. One such limitation arises when dealing with data stored in isolated data centers, where the vast volume of data makes it impractical to transmit and gather for training. Additionally, regulatory restrictions may prohibit data sharing across companies or countries. Furthermore, scenarios involving streaming data generated every second pose challenges due to the infeasibility of transmitting all the data to a central server. Apart from the technical difficulties in transmitting data from devices to a central server, gathering siloed data for processing and training also presents drawbacks. Data transmission, especially with large datasets, demands substantial bandwidth, resulting in communication latency. Moreover, data privacy concerns escalate when data is transmitted and leaves client devices or data storage centers. This transmission process also incurs additional energy costs. Therefore, in many instances, a problem that needs to be solved is to design methods that circumvent data transmission while achieving competitive model performance compared to models trained on centralized datasets are needed in applied fields.

To conquer the difficulties, distributed learning, also known as decentralized learning, or federated learning, offers methods where training is performed across multiple nodes instead of centralizing all the data in a single location. In this approach, the data remains distributed on individual devices, and the learning process occurs locally on each device. The main strengths of distributed learning are its ability to address privacy, security, and scalability concerns associated with centralized data storage and processing. However, there are some challenges related to decentralized data. Firstly, heterogeneous data is one of the main challenges in distributed learning as data across different devices may have varying distributions, quality, and feature spaces. Dealing with such heterogeneous data poses challenges in aggregating models effectively and achieving good generalization performance. Secondly, devices often hold non-independent and identically distributed (non-IID) data due to their diverse sources and contexts. Learning from non-IID data introduces challenges in model aggregation and convergence.

Given the practical problems and challenges mentioned earlier, this disclosed embodiment aims to tackle the issues through the introduction of a novel collaborative learning strategy. This approach incorporates the “rebasin” technique and uses it to align model knowledge and bring the aligned knowledge into the collaborative learning process. More specifically, under the setting of collaborative learning, in training stage for any model A in the system, the rebasin technique is applied to permute the weights of other models based on its behavior on a common evaluation dataset (the common evaluation dataset is a dataset that all entities in the system have access to), and then the aligned knowledge is introduced as a regularization for model A in its training stage. This results in a refined and better-aligned model knowledge being pooled together within the same loss basin and subsequently fed to the aggregation operator during each communication round. This embodiment introduces a framework for an aligned strategy in collaborative training on siloed datasets.

A system may uses a technique similar to weight matching, but it is done in a recursive layer-wise manner and does not incorporate activation matching. In addition, this system would use local private dataset to do knowledge alignment, but not introducing a public dataset to do so. Moreover, the aggregated information is not brought into the local training stage as regularization. On the other hand, the rebasin focuses on the problem of permuting the weights of the one well-trained model towards the basin of the other well-trained model while our method allows for permuted knowledge exchange during the training procedure.

In embodiment, a collaborative learning method is presented that stores data locally and each party of the system trains their own model locally with information for aligned knowledge shared by other parties. In this disclosure, the knowledge is shared directly between parties instead of having a central server aggregating the knowledge. The aligned knowledge is introduced as regularization in the training stage. In this embodiment, under the setting of collaborative learning, in training stage for any model A in the system, client A first share the set of activations of its local model on the rebasin technique that is applied to permute the weights of other models based on its behavior on the common evaluation dataset (the common evaluation dataset is a non-private dataset that all entities in the system has access to), and send such activation to all other entities. Then the other entities permute their local model using such activations and send the permuted model to A. A then use the aligned/permuted models as a regularization for model A in its training stage. Since the models shared to A is permuted already and cannot recover the unpermuted model of other entities from the permuted model, the privacy is preserved. In this way, it enhances performance, including convergence rate, training robustness, and generalized accuracy limit, privacy among other benefits. The proposed method empowers a more effective and private collaboration process for collaborative learning. Comparing to federated knowledge distillation, this embodiment provides extra information (activations of all layers instead of the last layer) to enhance collaborative learning performance.

Application: This embodiment can be used by training deep models or neural networks using decentralized learning, multiple party collaborative learning in industrial IoT, sensor networks, autonomation, artificial intelligence for production.

Context of this embodiment: The rebasin focuses on the problem of permuting the weights of the one fully-trained model towards the basin of the other fully-trained model and the study is limited to only two fully-trained models. In this embodiment, the idea of using the rebasin approach in the training across multiple (more than two) entities in their training stages is employed.

Problem Formulation: Consider a system that consists of several entities, and each client has its own private data stored locally as well as a shared and common evaluation dataset. All parties have access to a local computing unit and can communicate with some of the other entities in the system. Each client is allowed to send/receive parameters but cannot share their own private data. In other words, those entities are collaboratively training their models by sharing knowledge in the system.

Consider N entities, where each client n=1,2, . . . , N has its own private data Dₙ={xᵢⁿ, yᵢⁿ}ᵢ₌₁^{M}^{ₙ}, common evaluation set D_{common}={xᵢⁿ, yᵢⁿ}ᵢ₌₁^{L} and parameters θₙ∈R^{θ}. Assume that the entities follow from a communication graph, denoted as G∈R₊^{n×n}, where nodes in G are the entities and the edges are connections between entities. Each client is allowed to send/receive parameters but cannot share their own private data. Furthermore, each client is associated with a local training loss Lₙ(xₙ, yₙ, θ). With a goal to find the “global” parameters θ that minimize the sum of the training loss of entities, i.e.,

$$θ = arg min {\sum }_{n ∈ \{ 1 , 2 , … , N \}} {L}_{n} ( {x}_{n} , {y}_{n} , θ ) . \qquad ( 13 )$$

Rebasin with permutation for given two models:

1. Permutation of model weights: permutation is a linear transformation of model parameters in a layer-by-layer fashion. The permuted lth fully-connected layer (in a multi-layer perceptron) parameterized by [symbol] ∈R^{d}^{ₗ}^{×d}^{ₗ₊₁} and bias bₗ∈R^{d}^{ₗ} with the permutation matrix P∈S^{d}^{ₗ₊₁} can be written as:

$$= {PW}_{l} , {B}_{l} = {PB}_{l} \qquad ( 14 )$$

Convolutional layers can be permuted in a similar fashion

2. Permuting one model to the basin of the other with activation matching: Assuming there are two model A and B and each model contains the set of n layers. By running the model through one data point, one can obtain a set of activations where the lth layer activations Zₗ=[z_{l,1}^{T}, . . . , z_{l,n}^{T}]. One will conduct permutation at each layer with the permutation matrix Pₗ for the lth layer

$${P}_{l} = arg {min}_{{P}_{l} ∈ {S}^{{d}_{l + 1}}} {\sum }_{i = 1}^{n} ‖ {Z}_{l + 1 , i}^{( A )} - {P}_{l} {Z}_{l + 1 , i}^{( B )} ‖ \qquad ( 15 )$$

This method can be extended to other type of neural network, such as convolutional neuron network.

### Solution: Collaborative Rebasin with Common Evaluation Dataset Approach

Assume that T communication rounds and one set of initial parameters θ⁰. Moreover, assume that at each round for any given client (node in the graph) i it wishes to transfer the parameters

$${\{ {θ}_{j} \}}_{\{ j : G ( i , j ) \neq 0}$$

within the basin or its own parameters θᵢ. Here G is the graph connecting the entities, where the nodes are the entities and edges are connections between entities. One variation of such graph could contain a special node, the server, where all other nodes have connection to it. More specifically, the following steps will take place. One variation of the

1. Initiate each client's model [symbol] to be θ⁰.

2. The following updates will take place at every communication round, for t=1,2, . . . , T:(or until convergence) repeat step 3-6.

3. Evaluate locally model θᵢ^{t} on common evaluation dataset: For each client i, evaluate the locally-updated model θᵢ^{t} on the common evaluation dataset Dcommon to obtain a set of activations Zi={θᵢ^{t}(d)|d∈D_{common}}

4. Send and receive activations to/from neighbors: For each entity i, send the activation Zi its neighbors j: G(i,j)≠0 and receive activations {Zj|j: G(i,j)≠0}.
a. In the special case where a server is present, each client i sends the activations to the server, and server select one client to be the reference of this round (setting it to number 1) and broadcast Zi to all entities.

5. Find optimal permutations for each model. For each client i, repeat the following for each of its neighbor j:
a. G(i,j)≠0: calculate corresponding permutations based on activation matching for received activations based on the common evaluation dataset.

$${π}_{j}^{t} = arg {min}_{P} {‖ {θ}_{1}^{t} - P ( {θ}_{j}^{t} ) ‖}_{F} ( for weights matching ) , \qquad ( 16 )$$

$$and$$

$${π}_{j}^{t} = arg {min}_{P} {\sum }_{d ∈ {D}_{common}} {‖ {Z}_{d}^{j , t} - P {Z}_{d}^{i , t} ‖}^{2} \qquad ( 17 )$$

Here, each Z_{d}^{j,t} is the activation of model θⱼ^{t} on data point d∈D_{common}.
b. Then compute permuted local model θ_{i→j}^{t}=πⱼ^{t}θᵢ^{t} and send the permuted model to neighbor j
c. In the special case where a server is present, each client permute their model to model 1 by solving the permutation matrix
   πᵢ^{t}=arg [symbol] Σ_{d∈D}_{_{common}}∥Z_{d}^{1,t}−PZ_{d}^{i,t}∥², and send the permuted model [symbol] πᵢ^{t}θᵢ^{t} to the server

6. Similarly, each client i will receive a set of permuted models {θ_{j→i}^{t}|j: G(i,j)≠0} from its neighbors

7. for each client i, update its loss term to

$$= {\sum }_{( x , y ) ∈ {D}_{i}} {L}_{i} ( x , y , {θ}_{i}^{t} ) + {\sum }_{j : G ( i , j ) \neq 0} {λ}_{j} {‖ {θ}_{i}^{t} - {θ}_{j \to i}^{t} ‖}_{2} \qquad ( 18 )$$

in the special case where a server is present, the server aggregate the permuted model θ_{agg}^{t} into one model, using linear combination

$${θ}_{a g g}^{t} = linear combination ( {θ}_{1}^{t} , , … , ) \qquad ( 19 )$$

and broadcast θ_{agg}^{t} to all entities. Then all entities compute the regularized loss

$$= {\sum }_{( x , y ) ∈ {D}_{i}} {L}_{i} ( x , y , {θ}_{i}^{t} ) + {λ}_{i} {‖ {θ}_{i}^{t} - {θ}_{agg}^{t} ‖}_{2}^{2} \qquad ( 20 )$$

8. Back propagate and update local parameters θᵢ^{t}

FIG. 3C flowchart for Co-rebasin with public dataset: each client receives model parameter sets from its neighbors, then permute the received parameters to align with the client's own parameter space based on the public dataset, and incorporate such permuted parameters into the client's parameters.

The machine-learning models described herein can be used in many different applications. As described above, the raw source data that is locally-stored may be image data, sound data, or the like, and thus various applications in which this data is retrieved or used are shown in FIGS. 6-11 as an example. Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, microphone, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine-learning algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may be any of the processors or processor subsystems described above with reference to FIGS. 1-2. and may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, tensor processing unit, graphics processing unit, ASIC or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more machine-learning algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the machine-learning algorithms and/or methodologies as disclosed herein. Non-volatile storage 516 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIGS. 6-11 illustrate embodiments of environments in which the federated learning systems described herein can be implemented. Each of these embodiments show an embodiment of a client device. Data originating from the sensor 506 in these embodiments may be the raw source data that is used to train a machine learning model onboard the device (client), but not transferred to the server for protection of the data. FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, microphone, radar sensors, ultrasonic sensors, LiDAR sensors, and/or position sensors (e.g. GPS). One or more of the one or more specific sensors may be integrated into vehicle 600. Sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects. The raw source data for the federated learning may include the raw images of the vehicle surroundings, however the vehicle's processing of the objects in the surrounding environment might alter weights in the machine learning model used onboard the vehicle; these adjusted weights can then be sent back to the server's models for updating.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

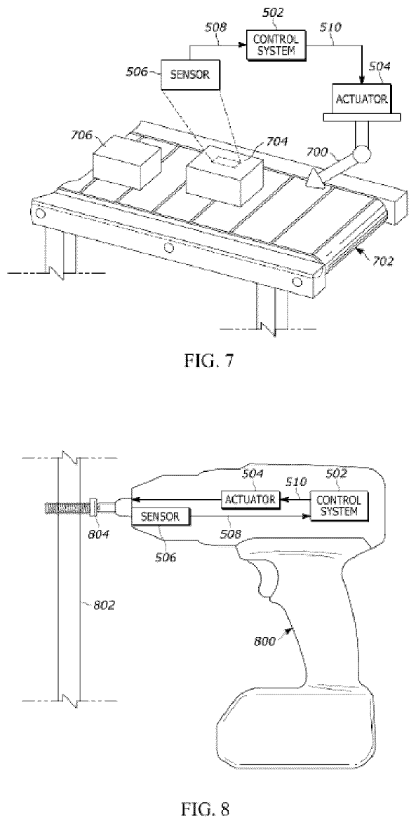

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

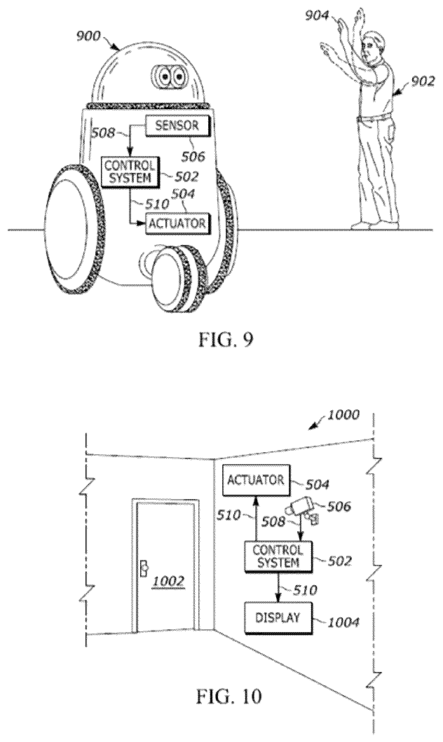

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity or client of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

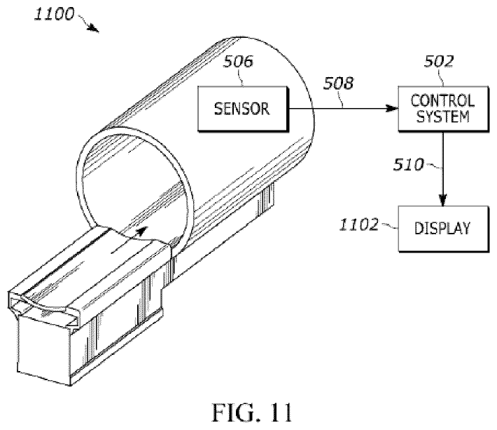

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region. The sensed image may be used internal in the hospital environment for training machine learning systems within the hospital (client), however this data is not sent to the server for training of the server's models. Instead, the hospital's adjusted weights that are adjusted based on the sensed images may be sent to the server for adjustment of the weights on the server side.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of training neural networks with federated learning, the method comprising:
sending at least a portion of a server-maintained machine learning model from a server to a plurality of clients, yielding a plurality of local machine learning models;
at each of the plurality of clients, training the plurality of local machine learning models with locally-stored data that is stored locally at that respective client, wherein training at each client includes determining a respective cross entropy loss for each of the plurality of local machine learning models;
updating respective weights for each of the plurality of local machine learning models;
evaluating the updated respective weights on a common dataset at each layer of the local machine learning models to obtain activation outputs for each layer;
transferring the activation outputs from each client to the server without transferring the locally-stored data of the clients;
receiving at the server, the activation outputs from each client;
selecting one activation output from one of the each client;
permuting the activation outputs according to the one respective updated weight to match a dimension of the selected client to obtain a matrix;
sending, by the server, the matrix to each client;
permuting, by each client, the plurality of local machine learning models based on the matrix to obtain permuted weights;
receiving, by the server, the permuted weights;
aggregating, at the server, the permuted weights from each of the plurality of local machine learning models to obtain an aggregated server-maintained machine learning model;
transferring the aggregated permuted weights to each of the plurality of clients; and
updating each of the plurality of local machine learning models with the aggregated permuted weights.

2. The method of claim 1, wherein the permuting according to the respective updated weights is according to:
$$= P {W}_{l} , {B}_{l} = P {B}_{l} .$$

3. The method of claim 2, wherein the permuting to obtain the matrix is according to
$$P = arg min {\sum }_{i = 1}^{n} ‖ {Θ}_{A} - P {Θ}_{B} ‖ .$$

4. The method of claim 3, wherein each layer of the matrix is according to
$$P = arg min {\sum }_{i = 1}^{n} ‖ {Θ}_{A} - P {Θ}_{B} ‖ .$$

5. The method of claim 4, wherein the selecting is a random or pseudorandom selection.

6. A system of training neural networks with federated learning, the system comprising:
memory storing instructions; and
at least one processor that, when executing the instructions stored in the memory, collectively perform:
sending at least a portion of a server-maintained machine learning model from a server to a plurality of clients, yielding a plurality of local machine learning models;
at each of the plurality of clients, training the plurality of local machine learning models with locally-stored data that is stored locally at that respective client, wherein training at each client includes determining a respective cross entropy loss for each of the plurality of local machine learning models;
updating respective weights for each of the plurality of local machine learning models;
evaluating the updated respective weights on a common dataset at each layer of the local machine learning models to obtain activation outputs for each layer;
transferring the activation outputs from each client to the server without transferring the locally-stored data of the clients;
receiving at the server, the activation outputs from each client;
selecting one activation output from one of the each client;
permuting the activation outputs according to the one respective updated weight to match a dimension of the selected client to obtain a matrix;
sending, by the server, the matrix to each client
permuting, by each client, the plurality of local machine learning models based on the matrix to obtain permuted weights.
receiving, by the server, the permuted weights;
aggregating, at the server, the permuted weights from each of the plurality of local machine learning models to obtain an aggregated server-maintained machine learning model;
transferring the aggregated permuted weights to each of the plurality of clients; and
updating each of the plurality of local machine learning models with the aggregated permuted weights.

7. The system of claim 6, wherein the permuting according to the respective updated weights is according to:
$$= {PW}_{l} , {B}_{l} = P {B}_{l} .$$

8. The system of claim 7, wherein the permuting to obtain the matrix is according to
$$P = arg min {\sum }_{i = 1}^{n} ‖ {Θ}_{A} - P {Θ}_{B} ‖ .$$

9. The system of claim 8, wherein each layer of the matrix is according to
$$P = arg min {\sum }_{i = 1}^{n} ‖ {Θ}_{A} - P {Θ}_{B} ‖ .$$

10. The system of claim 9, wherein the selecting is a random or pseudorandom selection.

11. A robotic system operated by a neural network comprising:
memory storing instructions; and
at least one processor that, when executing the instructions stored in the memory, collectively train the neural networks with federated learning by:
sending at least a portion of a server-maintained machine learning model from a server to a plurality of clients, yielding a plurality of local machine learning models;
at each of the plurality of clients, training the plurality of local machine learning models with locally-stored data that is stored locally at that respective client, wherein training at each client includes determining a respective cross entropy loss for each of the plurality of local machine learning models;
updating respective weights for each of the plurality of local machine learning models;
evaluating the updated respective weights on a common dataset at each layer of the local machine learning models to obtain activation outputs for each layer;
transferring the activation outputs from each client to the server without transferring the locally-stored data of the clients;
receiving at the server, the activation outputs from each client;
selecting one activation output from one of the each client;
permuting the activation outputs according to the one respective updated weight to match a dimension of the selected client to obtain a matrix;
sending, by the server, the matrix to each client
permuting, by each client, the plurality of local machine learning models based on the matrix to obtain permuted weights.
receiving, by the server, the permuted weights;
aggregating, at the server, the permuted weights from each of the plurality of local machine learning models to obtain an aggregated server-maintained machine learning model;
transferring the aggregated permuted weights to each of the plurality of clients; and
updating each of the plurality of local machine learning models with the aggregated permuted weights.

12. The robotic system of claim 11, wherein the permuting according to the respective updated weights is according to:
$$= P {W}_{l} , {B}_{l} = P {B}_{l} .$$

13. The robotic system of claim 12, wherein the permuting to obtain the matrix is according to
$$P = arg min {\sum }_{i = 1}^{n} ‖ {Θ}_{A} - P {Θ}_{B} ‖ .$$

14. The robotic system of claim 13, wherein the permutation is performed on an activation for a layer with Zₗ=[z_{l,1}^{T}, . . . , z_{l,n}^{T}], wherein the permutation at each layer is performed according to
$${P}_{l} = arg {min}_{{P}_{l} ∈ {S}^{{d}_{l + 1}}} {\sum }_{i = 1}^{n} ‖ {Z}_{l + 1 , i}^{( A )} - {P}_{l} {Z}_{l + 1 , i}^{( B )} ‖ .$$

15. The robotic system of claim 14, wherein the selecting is a random or pseudorandom selection.

16. The robotic system of claim 15, wherein the robotic system is an autonomous driving vehicle.

17. The robotic system of claim 15, wherein the robotic system is a medical system.
